(19) United States
(12) Patent Application Publication
(10) Pub. No.: US 2026/0273831 A1
(43) Pub. Date: Sep. 17, 2026

(54) CALIBRATION DEVICE FOR AN EXTRUDED PLASTIC PROFILE STRAND AND METHOD FOR CALIBRATING AN EXTRUDED PLASTIC PROFILE STRAND AND CALIBRATED PLASTIC PROFILE

(71) Applicant: TECHNOFORM BAUTEC HOLDING GMBH, Lohfelden (DE)

(72) Inventors: Meritxell MORLANS, Lohfelden (DE); Günther ROSENAU, Lohfelden (DE); Samir YOUSSEF, Lohfelden (DE)

(21) Appl. No.: 19/168,043

(22) PCT Filed: Mar. 14, 2024
(86) PCT No.: PCT/EP2024/056821

§ 371 Date: Sep. 23, 2025

(30) Foreign Application Priority Data
Mar. 24, 2023 (EP) 23163995.6

(51) Int. Cl. B29C 48/90; B29C 48/12; B29L 31/00

(52) U.S. Cl. CPC B29C 48/904; B29C 48/12; B29L 2031/003

(57) ABSTRACT

A calibration device and a method for calibrating at least one extruded plastic profile strand enable a plastic profile to be calibrated such that at least two complementary elements of the at least one extruded plastic profile strand (50) to be calibrated, which are initially separated or spaced apart perpendicular to a direction of movement (F) through a calibrator body (31) and are not yet in a form fit connected state, are brought into the form fit connected state in a cross section perpendicular to the direction of movement upon reaching the output side (33) of the calibrator body.

### CROSS-REFERENCE TO RELATED APPLICATIONS

This application is the U.S. National Stage of International Application No. PCT/EP2024/056821 filed on Mar. 14, 2024, which claims priority to European patent application no. 23 163 995.6 filed on Mar. 24, 2023.

### TECHNICAL FIELD

The present invention generally relates to a calibration device for an extruded plastic profile strand, to a method for calibrating an extruded plastic profile strand and to a calibrated plastic profile.

### BACKGROUND OF THE INVENTION

A method for calibrating an extruded plastic profile strand and a calibration device for an extruded plastic profile strand are known from EP 0 584 476 A1.

Calibrated plastic profiles having form fit elements are known, e.g., from WO 2013/189604 A1. In the hollow chamber profiles shown therein, either (i) a single profile strand is extruded and calibrated and, after the completed calibration and cooling down, the same is closed, e.g., by form fit elements designed as a clip connection, or (ii) two separate profile strands are extruded and calibrated and, after calibration and cooling down, the same are connected by a form fit connection known as a roller joint.

Other calibrated plastic profiles having form fit elements which, as so-called anti-bimetal profiles or shear-soft profiles, have a longitudinal displacement of two profile parts are known from DE 199 56 415 C1, US 2020/0040640 A1 and EP 0 657 612 A1. In these calibrated plastic profiles having form fit elements, the corresponding elements or profile parts are also first extruded and calibrated and then connected after cooling down, e.g. by clipping.

DE 10 2018 132 434 A1 discloses a method for manufacturing two plastic profiles, which are connected by a positive fit/form fit, in an extrusion tool.

### SUMMARY OF THE INVENTION

It is one non-limiting object of the present teachings to disclose techniques for improving a calibration device for an extruded plastic profile strand and a method for calibrating an extruded plastic profile strand, which simplify and improve the manufacturing of calibrated plastic profiles having form fit elements, as well as to provide a calibrated plastic profile with improved functionality.

In one non-limiting aspect of the present teachings, a calibration device for an extruded plastic profile strand for calibrating the extruded plastic profile strand into a calibrated plastic profile may comprise a calibrator body having at least one channel, which extends in a movement direction and has at least one inlet and one outlet and has a cross-sectional shape perpendicular to the movement direction at the outlet, which corresponds to the calibrated external cross-section of the plastic profile to be calibrated. The calibrated plastic profile preferably comprises at least two complementary elements in the calibrated state on the output side and the at least two complementary elements form a form fit (positive locking) in the cross section perpendicular to the movement direction. Furthermore, the at least one channel preferably has a cross-sectional shape perpendicular to the movement direction at the inlet in which the at least two complementary elements of the plastic profile to be calibrated are separated perpendicular to the movement direction and do not form a positive fit. In addition, the at least one channel is preferably designed (configured) from the inlet to the outlet such that the at least two complementary elements of the at least one channel are formed along the movement direction in a manner that brings them progressively closer to each other and then together into one calibrating channel region such that the sections of the extruded plastic profile strand forming the at least two complementary elements are brought into a form fit at the outlet by plastic and/or elastic deformation.

By elastically and/or plastically deforming the areas of extruded plastic profile strands that form the form fit elements while they are still in the soft state inside the calibrator, it is possible to manufacture calibrated plastic profile strands in which the form fit elements are already connected at the output of the calibrator. This makes it possible to manufacture calibrated plastic profile strands with form fit elements that would otherwise be very difficult or impossible to bring into a form fit.

### BRIEF DESCRIPTION OF THE DRAWINGS

Further features and functionalities can be taken from the description of embodiments referring to the figures, in which:

FIG. 1 shows an extrusion arrangement (device) for plastic profile extrusion, in which an embodiment of the calibration device is provided and with which an embodiment of the method can be carried out;

FIGS. 2A-2D show a first embodiment of a calibration device for an extruded plastic profile strand, wherein FIGS. 2A to 2D respectively show the cross section of the calibration device at cross sections Q1 to Q4 indicated in FIG. 1;

FIGS. 3A-3D show a second embodiment of a calibration device for an extruded plastic profile strand, wherein FIGS. 3A to 3D respectively show the cross section of the calibration device at cross sections Q1 to Q4 indicated in FIG. 1;

FIGS. 4A-4D respectively show the same cross sections as in FIG. 3A to 3D, in which the cross section of the finished calibrated profile is superimposed in the background for clarification of the deformation;

FIGS. 5A-5D show a third embodiment of a calibration device for an extruded plastic profile strand, wherein FIGS. 5A to 5D respectively show the cross section of the calibration device at cross sections Q1 to Q4 indicated in FIG. 1;

FIG. 6 shows the extrusion arrangement of FIG. 1 with a cross-sectional view of the extrusion nozzle and the calibrator of the third embodiment; and

FIG. 7A shows the first embodiment from FIG. 2A with marking of a section by a hatched rectangle, FIG. 7B shows the section from FIG. 7A in an enlarged representation, and FIG. 7C shows a cross section of the upper profile 51 from FIG. 3D in an enlarged representation.

### DETAILED DESCRIPTION OF THE INVENTION

In the following description of embodiments, all features, even if they are described in connection with other features, are disclosed separately and as combinable with the features of other embodiments, even if this is not expressly described, unless the corresponding combination is not technically possible.

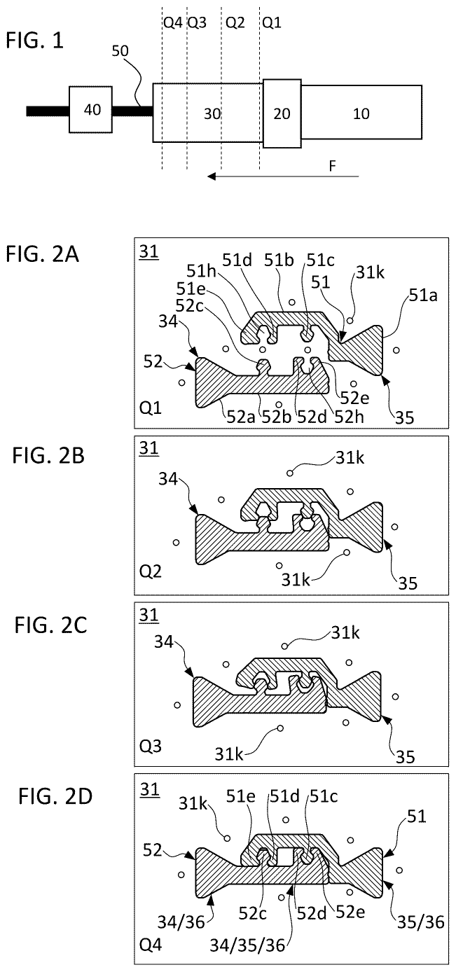

FIG. 1 schematically shows an extrusion arrangement (device) for plastic profile extrusion. The system comprises an extruder 10 which heats a plastic material in the usual manner, e.g., by one or more extruder screws, and outputs an extruded plastic material. An extrusion nozzle 20 for discharging an extruded plastic profile strand in the usual manner is arranged at an outlet of the extruder 10. Downstream of the extrusion nozzle 20, a calibration device 30 is arranged, which is designed in accordance with the teachings of the present application. A calibrated plastic profile 50 is output at the output side of the calibration device 30 shown on the left in FIG. 1. Therefore, the plastic material moves in the movement direction indicated by arrow F from the extruder 10 through the extrusion nozzle 20 into the calibration device 30 on the input side 32 shown on the right in FIG. 1/Fig. 6 and out of the calibration device 30 on the output side 33 shown on the left in FIG. 1. In the extrusion arrangement shown in FIG. 1, which is designed for a profile drawing process, a haul-off 40 is arranged (and shown) downstream in the movement direction F. The haul-off 40 draws/pulls the calibrated plastic profile 50 out of the calibration device 30 in the movement direction F in the usual manner.

In this extrusion arrangement, the conveying speed of the extruder 10 and the haul-off speed of the haul-off 40 are controlled or regulated in a usual way such that the plastic profile 50 is extruded and calibrated accordingly. This is known in the prior art and will not be described in more detail herein.

In FIG. 1, the hatched lines labelled Q1, Q2, Q3 and Q4 show the positions of cross sections through the calibration device 30 perpendicular to the movement direction F.

In FIGS. 2A to 2D, corresponding cross sections through a first embodiment of the calibration device 30 are shown. Viewing FIGS. 1 and 2A-2D together, the calibration device 30 comprises a calibrator body 31 having a channel 34, 35, 36 which extends in the movement direction F from the input side 32 to the output side 33 (refer to FIG. 6, which shows another embodiment of the present teachings, for indications of the input side 32 and the output side 33). The channel 34, 35, 36 has two channel regions 34, 35 upstream in the direction of the input side 32, each with its own input on the input side. These two channels 34, 35 extend downstream in the movement direction F in such a way that they come continuously closer to each other and are eventually brought together in the channel region 36 (see FIG. 2D).

In FIGS. 2A to 2D, the outer circumference (periphery, dimensions) of the calibrator body 31 is represented in each case by a rectangular box. The outer circumference (periphery, dimensions) of the respective channel regions 34, 35, 36 in FIGS. 2A to 2D corresponds to the outer circumference (periphery, dimensions) of the two plastic profile strands 51, 52 shown there in grey.

As can be clearly seen in FIG. 2A, although the two profile strands 51, 52 are not identical in cross section, they are of complementary design for the connection shown in FIG. 2D.

In the prior art, these two profiles would have to be extruded and calibrated separately and joined together after cooling down, e.g., by longitudinal displacement of one profile relative to the other profile.

As can be clearly seen from the sequence of cross sections Q1 to Q4 in FIGS. 2A to 2D, respectively, it is possible with the calibrator 30 of the first embodiment to connect these two profile strands 51, 52 in the calibrator 30 in a state in which the profile strands 51, 52 can (still) be deformed relatively easily before they emerge from the calibrator body 31.

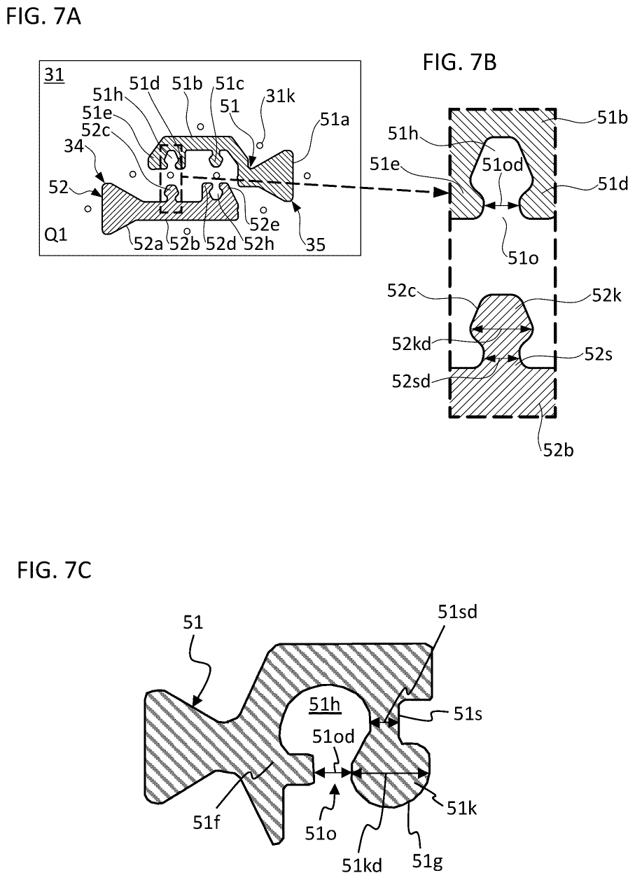

Reference is also made to FIG. 7A, in which the representation from FIG. 2A is shown with a section marked by a hatched rectangle, and to FIG. 7B, in which the section within the hatched rectangle of FIG. 7A is shown in an enlarged representation. The two profile strands 51, 52 each comprise a so-called roll-in body (or roll-in head) 51a, 52a. Such roll-in bodies are known in the prior art for connection to aluminium profiles by “rolling-in” (crimping) portions of the aluminum profiles around the roll-in bodies. The profile strands 51, 52 each comprise a respective profile bar 51b, 52b, which is integrally formed with the corresponding roll-in head 51a, 52a. In the upper profile strand 51 shown in FIGS. 2A-2D, this bar 51b is angled, while in the profile shown 52 shown in FIG. 2A and FIG. 7A below, the bar 52b is straight. However, these differences are of no importance for the present teachings. The two profile strands 51, 52 could also be identical in cross section. In addition, complementary elements are formed on each of the bars 51b, 52b, which are connected by positive locking (form fit, interlocking fit) in the joined state shown in FIG. 2D. FIG. 7B shows only one pair of the complementary elements, but the description and representation obviously also apply to the other complementary elements of FIGS. 2A to 2D. These complementary elements comprise a protrusion 51c, 52c having a stem 52s (FIG. 7B) protruding from the corresponding bar 51b, 52b and a head 52k (FIG. 7B) at the free end of the stem 52s. In cross section, the head 52k has a significantly larger diameter 52kd (FIG. 7B) than the stem 52s/52sd (FIG. 7B), as can be clearly seen in FIGS. 2A to 2D and 7A and 7B. Preferably, the diameter (lateral width) 52kd of the head 52k is at least 1.5 times, more preferably at least 2 times and even more preferably at least 2.5 times larger than the diameter (lateral width) 52sd of the stem 52s. A reasonable upper limit is a diameter 52kd of the head 52k which is at most 5 times, more preferably 4 times and even more preferably 3 times, such as 2.5 times larger than the diameter 52sd of the stem 52s.

A recess 51h, 52h is formed on the respective other profile strand as a second complementary element, the contour of which is adapted (configured) in cross section to receive the head 52k of the complementary protrusion 51c, 52c. The corresponding recess 51h, 52h is laterally delimited in cross section on both sides by walls of the profile regions 51d, 51e, 52d, 52e shown there as protrusions. The corresponding recess has an opening 51o (FIG. 7B) on its side facing the other complementary element (protrusion), the diameter 51od (FIG. 7B) of which is smaller than the diameter 52kd of the head 52k of the corresponding complementary protrusion 51c, 52c. The diameter 51od of this opening is such that it corresponds to the diameter 52sd of the stem 52s of the complementary protrusion 51c, 52c with a small overmeasure of 5% to 50%, more preferably 5% to 25% and even more preferably 5% to 15%, such as 10%. In other words, in the calibration device 30, the overmeasure is selected from a range of, for example, 5% to 25% of the added dimensions of the sections of the extruded plastic profile strand forming the at least two complementary elements. Depending on the field of application, a larger overmeasure could also be selected, but the diameter 51od of the opening 51o of the recess 51h, 52b should preferably be smaller than the diameter 52kd of the head 52k of the corresponding complementary protrusion 51c, 52c.

The calibrator device 30 of FIGS. 2A to 2D is designed in such a way that one profile strand 51 can be moved in one direction, in FIGS. 2A to 2D in the height direction, above the other profile strand 52 in the corresponding channel regions 35, 34. The two channel regions 35, 34 are formed in such a way that they are progressively formed closer to each other with (along) the movement direction F and are then brought together in a single channel region 36 (FIG. 2D).

This moves the complementary elements' protrusion and recess towards each other and, as can be clearly seen from FIGS. 2B to 2D, brings them into a positive fit.

The channel regions 35, 34 and 36 are designed (configured) such that, in particular in the channel regions between the cross sections Q2, Q3 and Q4 shown in FIGS. 2B and 2D, the channel regions have an overmeasure relative to the added dimensions of the corresponding protrusions 51e, 51d and 52c or 52d, 52e and 51c, which allow the wall sections 51e, 51d or 52d, 52h bounding the recess to move out of the way by elastic deformation in this case.

This means that since the profile strands 51, 52 already have a solid layer on the outside of the profile strand while moving in the corresponding channel regions 35, 34, which solid layer also has (exerts) a restoring force during deformation. The solid layer allows the desired elastic deformation below the elastic limit by means of a correspondingly designed course of the channel regions 35, 34 and 36 and then causes the protrusions 51e, 51d or 52d and 52e to snap back into the position shown in FIG. 2D after the heads have passed through the opening of the corresponding recess 51h or 52h. This means that, in the cross section Q2 shown in FIG. 2B, (i) the corresponding protrusions 51e, 51d or 52d, 52e are in the desired position with the corresponding shape of the recesses 51h or 52h, (ii) these protrusions are, in the position shown in FIG. 2C, elastically deformed in such a way that the head 51c or 52c can be pressed through the opening of the recess, and (iii) the corresponding protrusions 51e, 51d and 52d, 52e have been moved back into the position shown in FIG. 2B by the elastic restoring forces in the position shown in FIG. 2D.

The corresponding cross sections Q1, Q2, Q3 and Q4 do not, of course, have to be exactly at the positions shown schematically in FIG. 1. For example, the portion of the calibrator body 31 downstream of the cross section Q4 could also be even longer.

In FIGS. 2A to 2D, cooling channels in the calibrator body are represented schematically by small circles, some of which are labelled with the reference sign 31k. All such circles shown in FIGS. 2A to 2D are cooling channels, but adding reference signs for all these cooling channels would have made the drawing confusing, so only some of the circles are labelled with the corresponding reference sign.

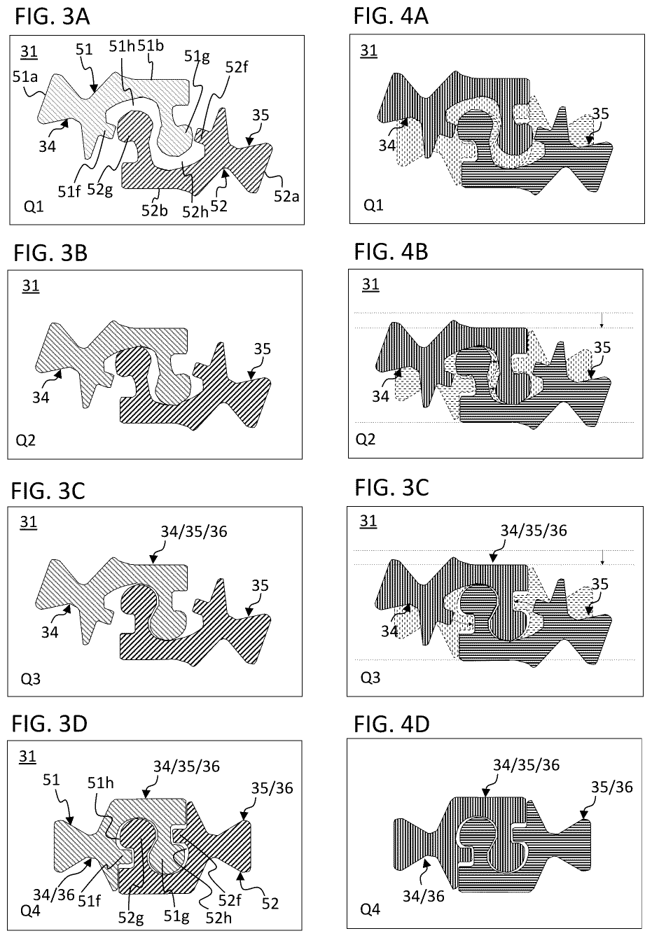

The design of the calibrator 30 such that the form fit of the complementary elements is manufactured by elastic deformation is not limited to the profile shape shown in FIGS. 2A to 2D. One-sided positive fits such as clip elements or roller joints of the type shown in WO 2013/189604 A1 or WO 2018/069859 A1 can also be connected by corresponding elastic deformation (joining) in the calibrator 30. The profile strands shown in FIG. 2 or the profile strands just mentioned could also be joined by plastic deformation, as described below with reference to FIGS. 3A to 3D, or by a combination of elastic and plastic deformation in the calibrator 30.

FIGS. 3A to 3D show a second embodiment of the calibrator body 31. The calibrator body 31 is again shown in the cross sections Q1 to Q4 indicated in FIG. 1 in the corresponding FIGS. 3A to 3D. Those elements and configurations such as shapes and dimensions and their areas which correspond to those of the first embodiment are not described and/or shown again. For example, in FIGS. 3A to 3D, no cooling channels 31k in the calibrator body 31 are represented and also described, although they may of course be present, and the dimensions and areas of the complementary elements are not described again, etc.

In the second embodiment, as shown in FIGS. 3A to 3D, the calibrator body 31 of the calibrator 30 has two separate inputs on the input side 32 (see FIG. 6), which open into separate channel regions 34, 35. Extruded plastic profile strands 51, 52, which are shown in cross section in hatching in FIGS. 3A to 3D, are respectively inserted into these channel regions 34, 35. The outer circumferences (peripheries, dimensions) of the profile strands 51, 52 shown correspond in turn to the inner contours of the corresponding channel regions 34, 35, 36.

FIG. 7C shows a cross section of the upper profile 51 from FIG. 3D in an enlarged representation. In the embodiment shown in FIGS. 3A to 3D, the two profile strands are identical in cross section. In contrast to the embodiment shown in FIGS. 2A to 2D, the two profile strands 51, 52 have protrusions 51g, 52g, which simultaneously serve as a protrusion with the stem 51s and the head 51k (FIG. 7C) and as one of the two protrusions forming a lateral wall of the corresponding recess 51h, 52h. The corresponding channel regions 34, 35, 36 are formed with corresponding regions for these protrusions.

As can be clearly seen from FIGS. 3A to 3D in the corresponding cross sections, the positive fit is not achieved by elastic deformation but rather by plastic deformation of the corresponding areas of the profile strands 51, 52. Specifically, the channel region 34 has a region for calibrating a roll-in head 51a of the profile strand 51, which is adjoined by (to) a bar 51b. A protrusion 51g includes the stem 51s, and the head 51k is formed at the free end of the stem 51s on the bar 51b. The description of FIGS. 2A to 2D in this regard is not repeated here. In contrast to the profile of FIGS. 2A to 3D, the other protrusion 51f, which together with the protrusion 51g forms the recess 51h, also adjoins the profile head 51a. Of course, this would also be possible in a different profile shape, in that the bar 51b is longer and the protrusion 51f is formed on the bar 52b. The channel region 34 has corresponding regions for calibrating these components of the profile strands 51a, as is evident from FIG. 3A.

In the embodiment shown in FIGS. 3A to 3D, the two profile strands are identical in cross section. In the prior art, such a profile strand could be calibrated by a calibrator, then cut accordingly and then connected to another piece of the profile strand by longitudinal displacement. However, such a profile doesn't exist in the prior art and connection by longitudinal displacement would be quite cumbersome, if not impossible.

With the calibrator 30 of the second embodiment, it is possible to extrude two identical profile strands and then calibrate and join them simultaneously in the same calibrator 30.

For this purpose, the two profile strands 51, 52 are guided through the corresponding channel regions 34, 35 not only in a first direction perpendicular to the movement direction (the height direction in FIG. 3) relative to each other, but the cross section of the profile strands 51, 52 is also changed/deformed in a second direction, which is perpendicular to the movement direction and oblique/perpendicular to the first direction (the horizontal direction in FIG. 3), by correspondingly shaping (configuring) the channel regions 34, 35. Thereby, both the protrusions 51g, 52g and the protrusions 51f, 52f are deformed, thus closing the opening 51o (FIG. 7C) of the corresponding recesses 51h, 52h compared to the open state in FIG. 3A, as shown in FIG. 3D. In other words, the two channel regions, and in particular the channel regions for the regions of the profile strands forming the complementary elements, are formed in such a way that they initially come closer together along the movement direction F and are subsequently brought together in one channel region 36. This formation of the channel regions 34, 35, 36 makes possible the plastic deformation and the generation of the positive locking (form fit) of the corresponding complementary elements, as shown in FIG. 3D. The corresponding regions of the profile strands of course also have a solid layer on their outer side in this case, but these are deformed beyond the elastic limit (yield point) by (due to) the corresponding design of the channel regions 34, 35, 36.

FIGS. 4A to 4D respectively show the same cross sections as in FIGS. 3A to 3D. In the background of the cross sections in FIGS. 4A, 4B and 4C, the final state of the calibrated plastic profile 50 at the exit (outlet side) from the calibrator 30, as it largely corresponds to the cross section in FIG. 4D, is also shown hatched. By superimposing these representations, it is easy to see how the channel regions 34, 35 are first brought closer together. in essence, in the height direction in FIGS. 4A to 4D, i.e., the height direction of the calibrator 30 of FIG. 1 (cf. FIGS. 4A and 4B), then further brought closer together in the transverse direction of the calibrator and brought together (cf. FIGS. 4B to 4D). The relatively strict separation of the movements first of the protrusions 51g, 52g and then of the protrusions 51f and 52f shown in FIGS. 3A to 3D and 4A to 4D is possible but not mandatory. The corresponding “movements” of the channel regions towards each other can also be formed in the calibrator body 31 in such a way that they take place more or less at the same positions of the cross sections in the movement direction F.

The calibrator body 31 shown in FIGS. 2A to 2D can be manufactured relatively easily in a conventional manner, e.g., as a calibrator block by wire erosion. With the comparatively complex course of the channel regions 34, 35, 36 in the calibrator body 31 of FIGS. 3A to 3D, this is not so easily possible. This calibrator body 31 could therefore be produced, for example, by manufacturing in several blocks in the longitudinal direction/movement direction F or by 3D printing with the relatively complex channel regions 34, 35, 36.

In summary, the calibration devices 30 of FIGS. 1 to 3D are calibration devices for an extruded plastic profile strand for calibrating the extruded plastic profile strand into a calibrated plastic profile 50 which emerges from the output on the output side 33. The calibrator body 31 has a channel 34, 35, 36 with two channel regions 34, 35 with separate inputs on the input side 32, which open out into one channel region 36 which ends in one output on the output side 33, at which the calibrated plastic profile 50 can be output. In the extrusion arrangement shown in FIG. 1, the calibrated plastic profile 50 is output by pulling it out of and through the calibrator 30.

The channel regions 34, 35 and 36 are designed and run/extend through the calibrator body 31 in the movement direction/longitudinal direction F in such a way that the corresponding complementary elements, which in the embodiments of FIGS. 2A to 2D and 3A to 3D are designed as protrusions 51c, 52c or 51g, 52g and corresponding recesses 51h, 52h, are first brought closer together while being moved along the movement direction (longitudinal direction) F and then brought together in a single channel region 36. The channel regions are designed in such a way that they have the overmeasure for calibration, which is also common in the prior art, and, in addition in the areas in which the complementary elements are brought together, in particular at/in the points/areas in which elastic deformation is to take place, an overmeasure permitting elastic deformation in addition to the added dimensions of the corresponding sections forming the sections of the plastic profiles forming the complementary elements.

In the case of purely plastic deformation, such as plastic deformation taking place between cross sections Q3 and Q4 in FIGS. 3C to 3D, no additional overmeasure is necessary, as plastic deformation (not elastic deformation) takes place.

The present teachings are applicable not only to a calibration device and the corresponding manufacturing of calibrated plastic profiles consisting of two separate plastic profile strands, but also to calibrated plastic profile strands which are extruded and calibrated in one piece and have corresponding fit elements.

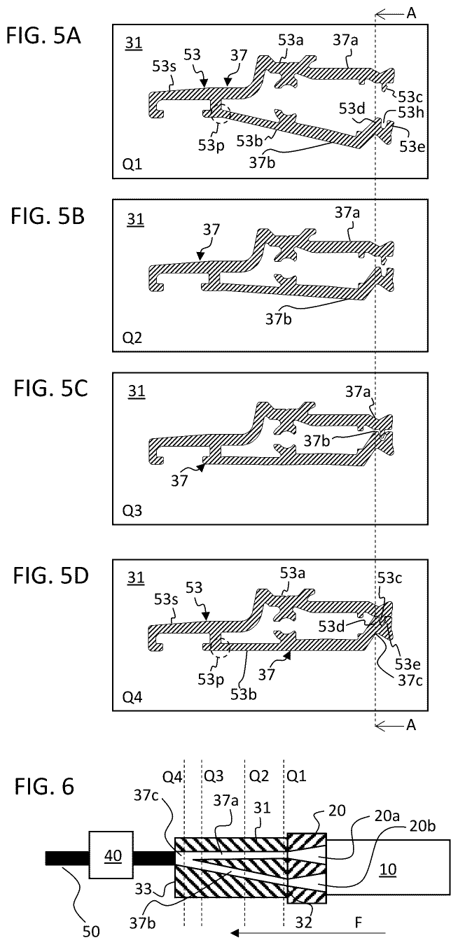

Such a third embodiment will now be described with reference to FIGS. 5A to 5D. This third embodiment of a calibration device 30 is shown in FIG. 6 in an extrusion arrangement of FIG. 1 in cross section along dashed line A-A indicated in FIGS. 5A to 5D. In FIG. 6, the extrusion nozzle 20 is also shown schematically in cross section along line A-A. Those elements and designs corresponding to those of the first/second embodiment, such as cooling channels 31k, are not described and/or shown again.

The calibrator 30 of the third embodiment has a calibrator body 31 that includes a channel 37, which is branched into two channel regions 37a and 37b. These two channel regions 37a, 37b are clearly recognisable in cross section in FIG. 6. The extrusion nozzle 20 accordingly has a branching nozzle shape with corresponding areas 20a and 20b. Thus, an extruded plastic profile strand can enter the channel 37 on the input side 32 of the calibrator body 31. The two channel regions 37a, 37b are brought continuously closer to each other along the longitudinal direction/movement direction F and are brought together in the region shown on the right in FIGS. 5A to 5D, as is obvious from FIGS. 5A to 5D, because the initially separate channel regions 34, 35 are brought continuously closer to each other along the longitudinal direction/movement direction F in the first and second embodiments. The parts of the regions 37a, 37b located more centrally in the calibrator body 31 are not brought together, so that the calibrated plastic profile 50 forms a hollow profile body.

The plastic profile, which can be calibrated with (using) the calibrator 30 of the third embodiment, has, on the left in FIGS. 5A to 5D, a stem 53s and then two bars 53a, 53b. The bar 37a has a protrusion 53c at its free end. The other bar 37b has a recess 53h, which is complementary to the protrusion 53c, at its free end opposite the free end of the bar 37a in the calibrated state. The recess 53h is defined/confined by corresponding side walls of the protrusions 53d, 53e. Although it is not represented in FIGS. 5A to 5D in as much detail as in FIGS. 2A to 2D and 3A to 3D, the protrusion 53c has a head whose diameter is greater than that of the stem of the protrusion 53c. The recess 53e in turn has an opening that faces the protrusion 53c, the diameter of which is in turn smaller than the diameter of the head of the protrusion 53c in the final state. In the embodiment shown in FIGS. 5A to 5D, the protrusion 53c is again brought into form-fit with the recess 53h by elastic deformation. However, a design that employs plastic deformation is also possible. This elastic deformation to form the positive fit is combined with a plastic deformation of at least one section of the profile strands, in this case the section 53b, in the area 53p circled in FIG. 5A. In this case too, the channel regions can be designed (configured) in such a way that the deformation in the region 53p or another region takes place elastically, so that when the positive fit (form-fit) is released, the hollow profile opens without having to be “bent open”. However, this is not the case in the embodiment shown in FIGS. 5A to 5D.

With the calibration devices 30 shown in FIGS. 1 to 6 or with differently designed calibration devices 30 for an extruded plastic profile strand, it is possible to carry out the following method for calibrating an extruded plastic profile strand into a calibrated plastic profile 50 which, in the calibrated state, has at least two complementary elements which form a form fit in the cross section perpendicular to a longitudinal direction of the calibrated plastic profile.

In this method, at least one extruded plastic profile to be calibrated is first introduced into at least one channel of the calibrator body 31. In the embodiments shown in FIGS. 1 to 4D, at least two extruded plastic profile strands are introduced into two separate inputs of corresponding channel regions of the calibrator body 31, while in the embodiment shown in FIGS. 5A to 5D, one extruded plastic profile strand is introduced into an input on the input side of the calibrator body 31. Of course, more than two plastic profile strands can also be introduced accordingly and brought into a form fit by corresponding complementary elements in the calibrator by forming and guiding channels accordingly.

After the insertion of the at least one extruded plastic profile strand to be calibrated into the at least one channel of the calibrator body, this plastic profile strand is moved through the channel or channels in the calibrator body in a movement direction F from the input side 32 to an output side 33, which is located on a side of the calibrator body 31 opposite the input side 32, for example by pulling/drawing. The inputs and channel regions are formed in such a way that the at least two complementary elements of the plastic profile to be calibrated are separated (spaced apart) from each other perpendicular to the movement direction F and do not form a positive fit at this stage.

During the movement of the plastic profile to be calibrated in the direction of movement F in the calibrator body, the corresponding regions of the plastic profile to be calibrated, which form the at least two complementary elements, are continuously brought closer and closer together (by corresponding formation (design) and a corresponding course (path) of the channel regions) and then brought together in such a way that the complementary elements are brought into a form fit by plastic and/or elastic deformation. During a further movement in the direction of movement direction F, a calibrated plastic profile, in which the two complementary elements form a form fit, is output on the output side.

In a method based on FIGS. 2A to 4D, one of each of the two complementary elements is inserted into an input in a channel region which is separate from the input and channel region into which the other of the two complementary elements is inserted.

In a method shown in FIGS. 5A to 5D, both areas of the plastic profile to be calibrated, which form the complementary elements, are introduced into the same channel but into initially separate areas of the same channel. Subsequently, these separate channel regions and thus the corresponding regions of the extruded plastic profile strand are first brought closer together and then brought together.

The extrusion arrangements and calibration devices of FIGS. 1 to 6 and the corresponding method can be used to manufacture a calibrated plastic profile 50 which is made, e.g., from polyamide with or without glass fibre reinforcement, which extends in a longitudinal direction and has a cross-sectional shape perpendicular to the longitudinal direction, in which at least two complementary elements form a positive fit in the cross section.

Due to the deformation in the soft state in the calibrator, it is possible to manufacture a form-fit of the at least two complementary elements in these calibrated plastic profiles, which, after cooling down, i.e. at room temperature, can be separated in any direction perpendicular to the longitudinal direction only by applying a force that damages the corresponding calibrated plastic profile. The same applies if the corresponding form fit is to be manufactured by movement perpendicular to the longitudinal direction. The plastic profile is dimensioned in such a way that it cannot be separated by a force in any direction perpendicular to the longitudinal direction, the amount of which is less than or equal to 300 N per 2 cm length of the plastic profile 50. If this amount of force is exceeded, separation will result in damage and/or destruction of the elements forming the positive fit or other areas of the calibrated plastic profile. Preferably, the amount with which the positive fit cannot be separated is less than or equal to 400 N per 2 cm length of the plastic profile, even more preferably less than or equal to 500 N per 2 cm length of the plastic profile. In particular with a profile of the type shown in FIGS. 2A to 5D, in which a first complementary element on a first plastic profile strand of the two separate calibrated plastic profile strands is a protrusion having a stem and a head at the free end of the stem, in which the head has a larger diameter in cross section than the stem, and in which the other, second complementary element on a second of the two separate plastic profile strands is formed as a recess which, in the calibrated state, has an opening of the recess in the cross section perpendicular to the longitudinal direction, the diameter of which is larger than the diameter of the stem but smaller than the diameter of the head, such a design of the calibrated plastic profile is easy to realise. All that needs to be done is to select the dimensions of the head and the corresponding elements delimiting the recess, such as the protrusions shown in FIGS. 2A to 5D, accordingly. Two separate profile strands connected by form-fit elements as taught in the present application make it possible to design shear soft profiles for connection metal profiles of window, door or faced elements which allow for relative movement of the metal profiles along their longitudinal direction. The embodiments in FIG. 2A to 4D are especially suitable for such shear soft connection profiles.

One embodiment of the present teachings is therefore also a plastic profile extrusion system having an extruder 10 that includes an outlet for discharging an extruded plastic material, an extrusion nozzle 20 arranged at the outlet of the extruder 10 for discharging an extruded plastic profile strand, a calibration device 30 downstream of the extrusion nozzle according to one of the above-described embodiments and/or the following patent claims, and a haul-off 40 for a calibrated plastic profile 50 discharged from the calibration device 30.

The profiles described in the present application as extruded and/or calibrated are longitudinal bodies that can be equally described as a profile or a profile bar or a profile strand.

It is explicitly emphasised that all features disclosed in the description and/or the claims are to be considered separate and independent from each other for the purpose of the original disclosure as well as for the purpose of limiting the claimed invention, independently of the combinations of features in the embodiments and/or the claims. It is explicitly stated that all range indications or indications of groups of units disclose any possible intermediate value or subgroup of units for the purpose of the original disclosure as well as for the purpose of limiting the claimed invention, in particular also as the limit of a range indication.

1. A calibration device for calibrating an extruded plastic profile strand into a calibrated plastic profile, the calibration device comprising:
a calibrator body defining at least one channel that extends in a movement direction and has at least one inlet and one outlet, the one outlet having a second cross-sectional shape perpendicular to the movement direction that corresponds to the calibrated external cross-section of the plastic profile to be calibrated,
wherein:
the calibrator body is configured such that, at the one outlet, the calibrated plastic profile comprises at least two complementary elements in the calibrated state that are form fit in the cross section perpendicular to the movement direction,
the at least one inlet of at least one channel has a first cross-sectional shape perpendicular to the movement direction such that the at least two complementary elements of the extruded plastic profile to be calibrated are separated in a direction perpendicular to the movement direction and are not in a state of being form fit, and
the at least one channel is configured from the at least one inlet to the one outlet such that the at least two complementary elements are progressively brought closer to each other along the movement direction and then are brought together into one calibrating channel region such that sections of the extruded plastic profile strand forming the at least two complementary elements are brought into a form fit connection at the one outlet by plastic deformation and/or elastic deformation.

2. The calibration device according to claim 1, wherein:
the first cross-sectional shape of at least one channel has at least first and second separate inlets configured such that a first one of the at least two complementary elements of the plastic profile to be calibrated enters the first separate inlet and a second one of the at least two complementary elements of the plastic profile to be calibrated enters the second separate inlet.

3. The calibration device according to claim 1, wherein:
the first cross-sectional shape is configured such that the at least two complementary elements of the plastic profile to be calibrated enter the at least one inlet in a spatially separated state.

4. The calibration device (30) according to claim 1, wherein:
the calibrator body has an input side and an output side, which is arranged on a side of the calibrator body opposite the input side in the movement direction,
the at least one channel extends from the input side to the output side and has the first cross-sectional shape perpendicular to the movement direction on the input side, in which the at least two complementary elements of the extruded plastic profile to be calibrated are separated perpendicular to the movement direction and do not form a positive fit, and has the second cross-sectional shape perpendicular to the movement direction on the output side, which corresponds to the calibrated outer cross-section of the plastic profile to be calibrated, and
the channel regions of the at least one channel which calibrate the at least two complementary elements of the plastic profile to be calibrated comprise, in a region along the movement direction in which the sections of the extruded plastic profile strand forming the at least two complementary elements are brought into a form fit connection by plastic deformation and/or elastic deformation, an overmeasure relative to added dimensions of the at least two complementary elements of the extruded plastic profile strand.

5. The calibration device (30) according to claim 1, wherein:
the calibrator body has cooling channels, and
at least one of the cooling channels extends between channel regions which come continuously closer to one another.

6. The calibration device (30) according to claim 1, wherein:
the at least two complementary elements of the calibrated plastic profile comprise a first complementary element that is a protrusion having a head at a terminal end of a stem, wherein the head has a larger diameter in cross section than the stem, and a second complementary element that is a recess that receives the head through an opening of the recess and is delimited by two lateral wall elements, which are formed by protrusions,
the opening of the recess has a diameter in cross section which is greater than the diameter of the stem but is smaller than the diameter of the head of the first complementary element, such that the form fit connection of the recess with the head in cross section encloses the head in two opposing directions, and
the at least one channel is formed from the inlet to the outlet such that the channel regions of the at least one channel, which calibrate the protrusion and the lateral wall elements delimiting the recess of the extruded plastic profile to be calibrated, continuously approach each other and are then brought together in one calibrating channel region to press the protrusion into the recess while undergoing plastic deformation and/or elastic deformation.

7. A method for calibrating at least one extruded plastic profile strand into a calibrated plastic profile which, in a calibrated state, comprises at least two complementary elements that, in a cross section perpendicular to a longitudinal direction of the calibrated plastic profile, are in a form fit connected state, the method comprising:
inserting the at least one extruded plastic profile strand into at least one channel of a calibrator body such that the at least one extruded plastic profile strand is movable along movement direction from an input side of the calibrator body to an output side, which is arranged on a side of the calibrator body opposite the input side in the movement direction, through the calibrator body, and such that the at least one extruded plastic profile strand has, upon insertion into the at least one channel, a cross-sectional shape perpendicular to the movement direction, in which the at least two complementary elements are separated in a direction perpendicular to the movement direction and are not in a form fit connected state;
moving the extruded plastic profile strand in the movement direction from the input side of the calibrator body to the output side through the at least one channel and calibrating the extruded plastic profile strand during this movement; and
outputting the calibrated plastic profile at the output side,
wherein:
while moving through the at least one channel sections of the extruded plastic profile strand forming the at least two complementary elements are continuously brought closer to each other along the movement direction and are then brought together into the form fit connected state while undergoing plastic deformation and/or elastic deformation, so that the at least two complementary elements form a positive fit in the form fit connected state in the cross section perpendicular to the longitudinal direction of the calibrated plastic profile.

8. The method according to claim 7, wherein:
in the inserting step, at least first and second extruded plastic profile strands are respectively inserted into at least first and second inlets of at least one channel of the calibrator body that are separated from each other such that a first one of the at least two complementary elements of the first extruded plastic profile strand enters the first inlet and a second one of the at least two complementary elements of the second extruded plastic profile strand the second inlet and are thus separated in a direction perpendicular to the movement direction and are not in a form fit connected state.

9. The method according to claim 8, wherein:
the at least first and second extruded plastic profile strands, when moving in the movement direction from the input side (32) of the calibrator body to the output side, are first moved through first and second channel regions which are separate from each other and are brought closer to each other and calibrated and are subsequently then brought together in a third channel region (36) and thereby brought into the form fit connected state by undergoing elastic deformation without plastic deformation, in that the elastic deformation is limited by the design of the channel regions in such a way that elastic deformation of solid but still soft complementary elements takes place without plastic deformation.

10. The method according to claim 8, wherein:
the at least first and second extruded plastic profile strands, when moving in the movement direction from the input side of the calibrator body to the output side, are first moved through first and second channel regions which are separate from each other and are subsequently continuously brought closer together while undergoing deformation and calibrated and then brought together in a third channel region and thereby brought into the form fit connected state by undergoing plastic deformation, in that the plastic deformation is controlled by the design of the channel regions in such a way that plastic deformation of solid but still soft complementary elements takes place.

11. The method according to claim 7, wherein:
in the inserting step, the at least one extruded plastic profile strand is inserted into the at least one channel of the calibrator body such that each one of the at least two complementary elements of the extruded plastic profile strand enters the at least one channel in a different region of the same inlet in a spatially separated manner.

12. The method according to claim 7, wherein:
the at least two complementary elements of the calibrated plastic profile comprise a first complementary element that is a protrusion having a head at a terminal end of a stem, wherein the head has a larger diameter in cross section than the stem, and a second complementary element that is a recess that receives the head and is surrounded by two lateral wall elements, which are formed by protrusions,
the opening of the recess has a in cross section which is larger than the diameter of the stem but is smaller than the diameter of the head of the first complementary element, so that the form fit connection of the recess with the head encloses the head in two opposing directions, and
while moving through the at least one channel, sections of the extruded plastic profile strand forming the protrusion and the recess are continuously brought closer to each other along the movement direction (F) and are subsequently brought together and by pressing the protrusion into the recess while undergoing plastic deformation and/or elastic deformation of the head and/or the lateral wall elements.

13. (canceled)

14. A calibrated plastic profile that extends in a longitudinal direction and has a cross-sectional shape perpendicular to the longitudinal direction, comprising:
a first calibrated plastic profile strand having first and fourth complementary elements, and
a second calibrated plastic profile strand having second and third complementary elements,
wherein:
the first and second complementary elements are in a form fit connected state in a cross section,
the third and fourth complementary elements are in a form fit connected state in the cross section,
the first complementary element is formed as a first protrusion having a first head at the terminal end of a first stem, the first head having a larger diameter in the cross section that is at least 2 times larger than a diameter of the first stem,
the second complementary element is a first recess that receives the first head through an opening of the first recess and is delimited by two lateral wall elements such that (i) the opening of the first recess has a diameter in the cross section which is 5%-50% larger than the diameter of the first stem but is smaller than the diameter of the first head, (ii) the first head is enclosed in the first recess in two opposing directions in the cross section and (iii) the first and second calibrated plastic profile strands are thus in the form fit connected state, and
the third complementary element is formed as a second protrusion having a second head at the terminal end of a second stem, the second head having a diameter in the cross section that is at least 2 times larger than a diameter of the second stem,
the fourth complementary element is a second recess that receives the second head through an opening of the second recess and is delimited by two lateral wall elements such that (i) that the opening of the second recess has a diameter in the cross section which is 5%-50% larger than the diameter of the second stem but is smaller than the diameter of the second head, (ii) the second head of is enclosed in the second recess in two opposing directions in the cross section and (iii) the first and second calibrated plastic profile strands are thus in the form fit connected state, form a plastic profile,
the first and second protrusions and the first and second recesses are configured such that the first and second calibrated plastic profile strands are displaceable relative to one another in the longitudinal direction at room temperature, and
separation of the form fit connection of the first and second protrusions and the first and second recesses at room temperature in any direction perpendicular to the longitudinal direction requires application of a separating force of at least 300 N per 2 cm length of the calibrated plastic profile.

15. The calibrated plastic profile according to claim 14, wherein:
the first protrusion forms one of the two lateral wall elements which delimit the second recess, and
the second protrusion forms one of the two lateral wall elements which delimit the first recess.

16. The calibrated plastic profile according to claim 14, wherein:
the calibrated plastic profile is composed of polyamide with glass fiber reinforcement, and
separation of the form fit connection of the first and second protrusions and the first and second recesses at room temperature in any direction perpendicular to the longitudinal direction requires application of a separating force of at least 500 N per 2 cm length of the calibrated plastic profile.

17. The calibration device according to claim 1, wherein the at least one channel is configured such that the extruded plastic profile strand is movable in the movement direction through the calibrator body by drawing the calibrated plastic profile from downstream of the outlet.
